(19) United States
(12) Patent Application Publication
(10) Pub. No.: US 2007/0053179 A1
(43) Pub. Date: Mar. 8, 2007

(54) Low profile light source utilizing a flexible circuit carrier

(76) Inventors: Slew It Pang, Penang (MY); Fook Chuin Ng, Penang (MY); Bee Yin Chua, Penang (MY); Alzar Abdul Karim Norfldathul, Seberang Peral (MY); Chee Foo Lum, Penang (MY)

Correspondence Address: AVAGO TECHNOLOGIES, LTD., P.O. BOX 1920, DENVER, CO, 80201-1920, US

(21) Appl. No.: 11/223,743

(22) Filed: Sep. 8, 2005

(51) Int. Cl. F21V 21/08

(52) U.S. Cl. 362/103; 362/106; 362/108; 362/294; 362/240

(57) ABSTRACT

A light source having a flexible light-generating module that includes a flexible circuit carrier, a plurality of light emitting dies, and a cover layer is disclosed. The flexible circuit carrier includes a sheet of flexible material having electrically conducting traces. The light emitting dies are electrically connected to the electrically conducting traces. The cover layer is constructed from a transparent, flexible material and covers the light emitting dies. The light-generating module can be attached to various surfaces to provide a light source that is non-planar as well as to surfaces that are piecewise planar. These more complex light sources can include garments that generate complex light patterns to call attention to the wearer and three-dimensional light sources. The light sources also provide improved heat-conduction and can be used to create non-rectangular back lights for displays.

### BACKGROUND OF THE INVENTION

Light emitting diodes (LEDs) are replacing conventional light sources such as florescent and incandescent light bulbs in many applications. LEDs have similar electrical efficiency and longer lifetimes than fluorescent light sources. In addition, the driving voltages needed are compatible with the battery power available on many portable devices.

To provide a replacement light source, however, light sources that utilize multiple LEDs are typically required. LEDs emit light in relatively narrow wavelength bands. Hence, to provide a light source of an arbitrary color, arrays of LEDs having different colors are often utilized.

In addition, to provide an LED light source of the intensity available from a conventional light source, multiple LEDs of each color must be included. The maximum light intensity from an LED is typically less than that available from an incandescent light of a few watts. Hence, to provide the equivalent of a 100 watt light bulb, a large number of low power LEDs must be combined in the replacement light source.

Light sources based on arrays of LEDs are typically constructed by attaching a number of packaged LEDs to a ridged printed circuit board (PCB), and sometimes on a flexible PCB, by soldering the individual LEDs to the PCB. Such light sources may be expensive to construct and have reliability problems. The PCB provides both the electrical connections to the LEDs and acts as a heat-dissipating element. The solder joints increase the cost of manufacture and are the source of component failures.

Further, there is a limit to the amount of heat that can be dissipated in the core of a PCB. The core has a limited thickness that sets the maximum amount of heat that can be moved along the length of the PCB. If the heat load becomes too great, the PCB can warp or flex. Such shape changes can alter the position of the LEDs relative to other components in the light source such as a lens that collimates the light or light pipes that distribute the light over a surface that is to be illuminated.

In addition, a number of applications require arrays of LEDs in which a large number of LEDs are mounted in a small space. For example, a light source that simulates a linear incandescent or fluorescent tube for illuminating the edge of a light pipe used in backlight for LCD displays can require an array of LEDs in which the individual LEDs are separated by less than 1 mm. The size of the LED packages sets an upper limit on the density of LEDs per unit area on the PCB board, and hence, such close spacing is not always possible.

It should also be noted that this type of ridged PCB light source is difficult to adapt to applications that require the LEDs to be positioned on a non-planar surface. Inexpensive PCBs are constructed by utilizing lithographic techniques in which an image of the desired conductor pattern is projected onto a metal clad surface that is covered by a photoresist. A portion of the photoresist is then removed from the unwanted areas of metal, which are then removed by etching. The areas of the photoresist that are removed are determined by the illumination pattern of the image. If the metal clad surface is not planar, the optical system needed for projecting the image on the surface is often too expensive to allow this type of inexpensive fabrication to be utilized. In fact, if complex surfaces are being utilized, conventional lithographic techniques may not function at all.

### SUMMARY OF THE INVENTION

The present invention includes a light source having a flexible light-generating module that includes a flexible circuit carrier, a plurality of light emitting dies mounted on the flexible circuit carrier, and a cover layer. The flexible circuit carrier includes a sheet of flexible material having electrically conducting traces. The light emitting dies are electrically connected to the electrically conducting traces. The cover layer (encapsulation material) is constructed from a transparent, flexible material and covers the light emitting dies. In one embodiment, the sheet of flexible material includes a heat-conducting layer, and the light emitting dies are mounted on the heat-conducting layer. In one embodiment, the heat-conducting layer includes a metallic layer on one surface of the flexible sheet. In one embodiment, the light source also includes a light pipe having a planar layer of transparent material characterized by top and bottom surfaces and one or more edge surfaces. The light-generating module is positioned adjacent to a first edge of the planar layer such that light from the light emitting dies enters the first edge and is reflected between the top and bottom surfaces. The light pipe includes light scattering centers for scattering light in the planar layer at angles that allow the light to exit through the top surface. In one embodiment, the light pipe further includes a second edge, and the light-generating module is also positioned adjacent to the second edge such that light from the light emitting dies enters the second edge and is reflected between the top and bottom surfaces. In one embodiment, the light-generating module also includes a sensor for measuring the intensity of light leaving the light pipe. In one embodiment, the cover layer includes an optical element for imaging light from at least one of the light emitting dies. In one embodiment, the optical element includes a lens constructed from the transparent, flexible material. In one embodiment, the light source also includes a shape-determining carrier having a non-planar surface bonded to the flexible circuit carrier. In one embodiment, the sheet of flexible material includes a heat-conducting layer on which the light emitting dies are mounted, and the non-planar surface is bonded to the heat-conducting layer. In one embodiment, the light source includes a garment having an outer surface that is visible when the garment is worn. The flexible light-generating AC module is attached to the outer surface such that light from the light emitting dies is visible to someone other than a person wearing the garment.

### BRIEF DESCRIPTION OF THE DRAWINGS

FIG. 1 is a simplified top view of a two-dimensional array of LEDs according to one embodiment of the present invention.

FIG. 2 is a cross-sectional view of the array shown in FIG. 1 through line 2-2.

FIG. 3 is a cross-sectional view through a portion of an LED array according to another embodiment of the present invention.

FIG. 4 is a top view of a light source according to one embodiment of the present invention.

FIG. 5 is a cross-sectional view of the light source shown in FIG. 4 through line 5-5.

FIG. 6 is a top view of a light source according to another embodiment of the present invention.

FIG. 7 is a top view of a light source according to another embodiment of the present invention.

FIG. 8 illustrates an example of a light pipe that utilizes a circular layer of plastic.

FIG. 9 is a cross-sectional view of a light source according to one embodiment of the present invention that includes a concave light-emitting surface.

FIG. 10 shows a pair of display panels attached to the front of a vest.

FIG. 11 shows a display panel in the form of a hatband attached to a hat.

FIG. 12 is a cross-sectional view of a light source according to another embodiment of the present invention.

### DETAILED DESCRIPTION OF THE PREFERRED EMBODIMENTS OF THE INVENTION

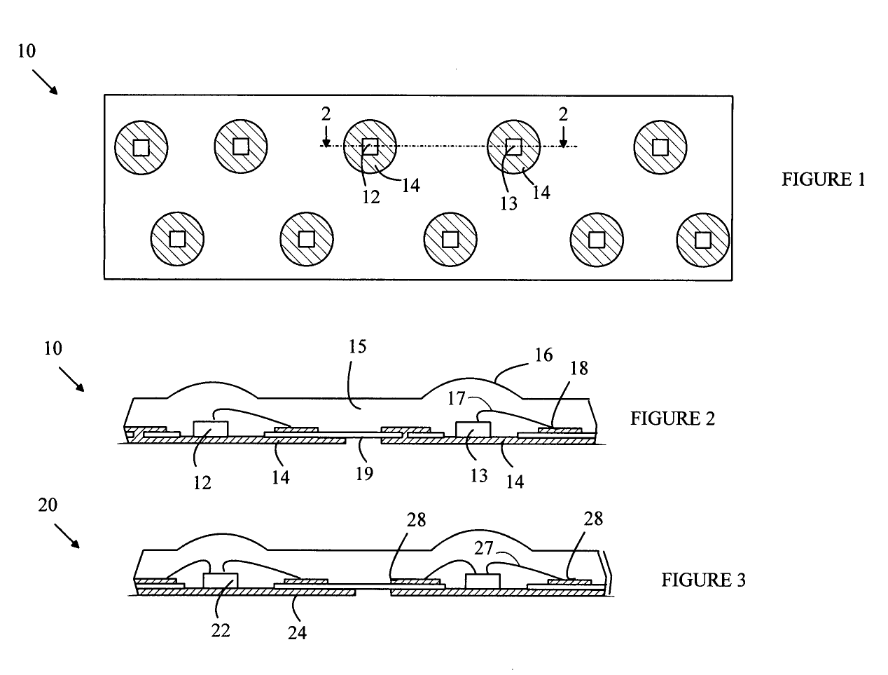

The manner in which the present invention provides its advantages can be more easily understood with reference to FIGS. 1 and 2, which illustrate a portion of a two-dimensional array of LEDs according to one embodiment of the present invention. FIG. 1 is a simplified top view of array 10, and FIG. 2 is a cross-sectional view of array 10 through line 2-2. Array 10 is constructed using a flexible circuit carrier. Flexible printed circuit boards or circuit carriers are known to the art, and hence, will not be discussed in detail here. For the purposes of the present discussion it is sufficient to note that flexible circuit carriers can be fabricated by depositing thin metal layers, or attaching metal layers, on a flexible resin substrate 19 and then converting the layers into a plurality of individual conductors by conventional photolithographic techniques. Array 10 includes two such metallic layers. A bottom layer 19 acts as a heat sink in addition to providing a common electrical connection for the LEDs of array 10. Exemplary LED dies are shown at 12 and 13. The top layer is patterned to provide traces such as trace 18 that are used to connect the LEDs to other circuitry that can be located on the flexible circuit carrier or on a separate substrate. The LEDs are connected to the traces using wire bonds such as bond 17. In the embodiment shown in FIGS. 1 and 2, the second connection to each LED is provided via the bottom of the LED die. To simplify the drawings, the circuit traces on the top surface of the flexible circuit carrier have been omitted from FIG. 1.

The LEDs can be bonded to the bottom conductive layer 14 using a heat-conducting adhesive. Since the die is mounted directly on the heat-conducting layer, the present invention provides improved heat transfer relative to prepackaged LEDs. As will be explained in more detail below, the bottom surface of the flexible circuit carrier can be placed in thermal contact with a surface that moves the heat to a location at which the heat can be more efficiently moved to the ambient environment.

After the dies have been attached to the flexible circuit carrier, a layer of clear, flexible, encapsulant 15 is molded over the flexible carrier. The encapsulant protects the dies from the environment. In addition, encapsulating layer 15 can include optical features such as lens 16 shown in FIG. 2. Examples of the encapsulation materials are silicone, which is generally flexible, and low modulus epoxy. In the case of epoxy, the encapsulant may have individual domes covering each LED chip that are non-continuous from chip-to-chip.

In some LED-based light sources, a portion of the light from the LED is converted to a different wavelength by including an appropriate phosphor in a layer over the LED. For example, a light source that is perceived as being white by a human observer can be constructed from a blue LED by converting part of the blue light to yellow light using a phosphor layer. The phosphor in question can be included in encapsulating layer 15 as well.

The above-described embodiments utilize a connection arrangement in which the bottom metallic layer of the flexible circuit carrier acts as a common conductor for the LEDs. However, embodiments in which the dies are separately connected to traces on the top surface of the flexible circuit carrier can also be constructed. Refer now to FIG. 3, which is a cross-sectional view through a portion of an LED array 20 according to another embodiment of the present invention. Array 20 also includes a plurality of LED dies 22 having two contacts for supplying power to the dies. In this embodiment, the contacts are located on the top surface of the dies and connected to traces 28 on the top surface of the flexible circuit carrier by wire bonds such as wire bond 27. The metal layer 24 conducts heat from the dies in a manner analogous to that discussed above.

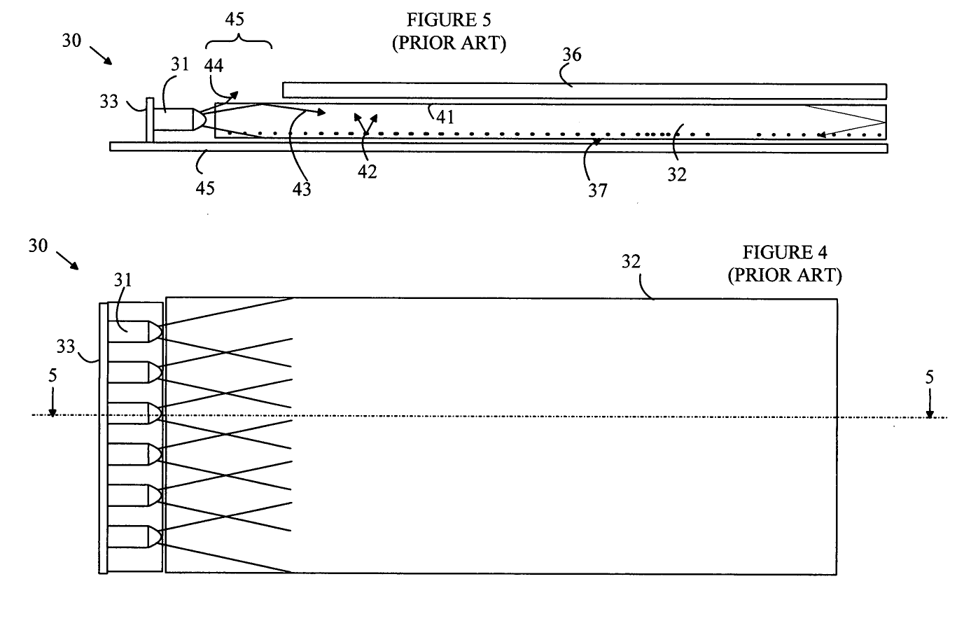

The present invention is useful in creating a number of different types of light sources. For example, LCD displays have become popular for use as television and computer monitors. A back-lighted LCD display utilizes a light pipe that is illuminated from one or more edges by an array of LEDs. Refer now to FIGS. 4 and 5, which illustrate a prior art light source of this type for illuminating an LCD display 36. FIG. 4 is a top view of light source 30, and FIG. 5 is a cross-sectional view of light source 30 through line 5-5 shown in FIG. 4. Light source 30 utilizes an array of LEDs 31 to illuminate a light pipe 32. The LEDs are mounted on a circuit board 33 that is mounted on a second board 45 that provides power to the LEDs. The LEDs are positioned such that light leaving the top of each LED illuminates the end of light pipe 32. The light 43 entering light pipe 32, at an angle with respect to the surface 41 that is less than the critical angle, is reflected back and forth within light pipe 32 until the light is either absorbed or scattered by particles 42 on surface 37. The scattered light that strikes surface 41 at angles greater than the critical angle escapes from the light pipe and illuminates the back surface of LCD display 36. The bottom surface of the light pipe is covered with a reflective material; hence, any light striking the bottom surface is reflected upward.

In the region of the light pipe near the LEDs, some of the rays will enter the light pipe at angles greater than the critical angle and immediately escape through the top surface of the light pipe as shown at 44. It should be noted that rays striking the bottom surface at angles greater than the critical angle will be reflected upwards at angles greater than the critical angle with respect to surface 41 and will also be lost. As a result, region 45 of the light pipe is not used to illuminate the LCD display. This region acts as a mixing region for mixing the light from the various LEDs.

It should be noted that the amount of light that is lost through region 45 would, in general, depend on the vertical positioning of the LEDs. If the LEDs are too low, then more light will leave region 45, since a greater fraction of the light leaving the LEDs will strike surface 41 at angles greater than the critical angle. In addition, the size of region 45 is also dependent on the vertical positioning of the LEDs to some extent. While vertical-positioning errors can be accommodated by increasing the size of region 45, this solution increases the size of the display and the power needed to provide a given level of illumination to the LCD display.

The size of mixing region 45 also depends on the separation between the individual LEDs. The LEDs typically include LEDs that emit light in three wavelength bands, namely, red, blue, and green. The relative intensities of the light emitted in the bands determine the color of the light source as perceived by a human observer. Since each LED is typically limited to emitting light in only one band, the LEDs are normally arranged in an order in which each LED emits light in a different band from that of its neighbors. Mixing region 45 must be long enough to assure that light from a number of neighboring LEDs is mixed when the light leaves mixing region 45 to assure that there are no color variations in the regions beyond the mixing region. Accordingly, designs in which three LEDs that emit light in different bands are placed as close to one another as possible are preferred, since such an arrangement provides the better mixing of the colors in any given mixing region. In prior art systems of the type shown in FIGS. 4 and 5, the minimum spacing for the LEDs is limited by the packaging of the LEDs, and hence, larger mixing regions are needed.

It should also be noted that the above-described LCD light source utilizes light injection along only one edge of the light pipe. If the light pipe is large, additional LEDs must be provided along other edges. In such a case, the construction is further complicated by the need to bond separate LED arrays to each of the edges. As noted above, the relative positioning of the LEDs relative to the light pipe must be maintained within tight tolerances. The additional light source further exasperates this tolerance problem.

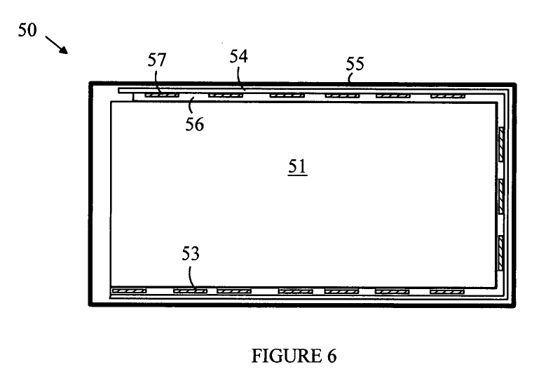

Refer now to FIG. 6, which is a top view of a light source according to another embodiment of the present invention. Light source 50 includes a light pipe 51 of the type discussed above. Light pipe 50 is illuminated along its edges by a flexible light source of the type discussed above. The flexible light source includes a number of LED dies 53 connected to a flexible circuit carrier 54 that is wrapped around the edge of light pipe 51 and held in place by a clamp 55. The flexible transparent encapsulating layer 56 is pressed against the edge of the light pipe by clamp 55. A layer of index of refraction matching material can be applied between the edge of the light pipe and the encapsulating material to reduce reflections at the interface. The flexible encapsulating material is also resilient, and hence, can provide a means to accommodate local imperfections in the edge of the light pipe or the dimensions of the clamp.

In some backlight designs, a photosensor is incorporated in the system to measure the intensity of each color or light within the light pipe. The sensor output is used in a feedback system that maintains the intensity of each color of light within predetermined limits within the light pipe. The photosensor may be included in the dies that are connected to the flexible circuit carrier. Such a sensor is shown at 57 in FIG. 6.

Since the LED dies are considerably smaller than the packaged LEDs discussed above, the distance between the LED dies on the flexible circuit carrier can be much smaller. Hence, the area of the light pipe that must be devoted to the mixing zone discussed above is substantially smaller.

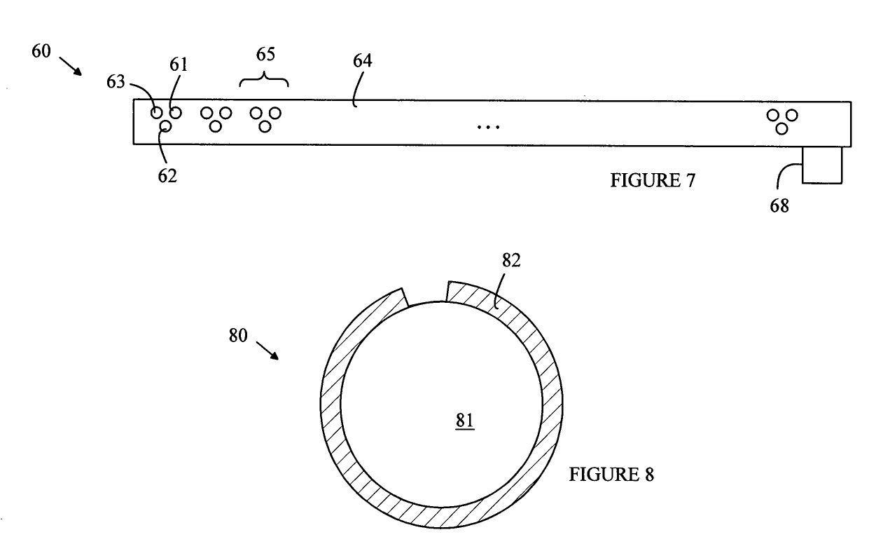

In addition, the smaller die size allows a multicolor light source to be constructed in a smaller space. Refer now to FIG. 7, which is a top view of a light source 60 according to another embodiment of the present invention. Light source 60 consists of a number of groups of LED dies such as group 65. Each group of dies includes dies that emit different colors of light. For example, dies 61-63 are dies for emitting red, blue, and green light respectively. When viewed at an appropriate distance, the dies in each group appear to be a single point of light of a color determined by the relative intensities of the light from the individual LEDs.

The dies are mounted on a flexible circuit carrier 64 with a flexible encapsulating layer over the dies. The light source is in the form of a strip that has a connector 68 that can be attached to a PCB board for powering the LEDs.

Light source 60 is useful in creating light sources such as light source 50 shown in FIG. 6. It should be noted that light source 60 can also be used to create back lights based on light pipes that are not rectangular in shape. An example of a light pipe comprising a circular layer of plastic is shown in FIG. 8. Light source 80 includes a light pipe 81 that has a light strip 82 of the type discussed with reference to FIG. 7 wrapped around the edge of the circular sheet of plastic. Light source 80 appears to be a uniformly illuminated circular area that emits light in a direction perpendicular to the plane of the figure.

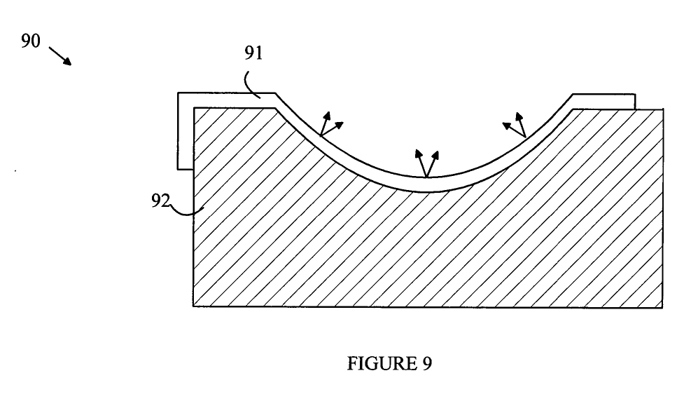

A flexible light source according to the present invention is useful in creating a non-flat light-emitting surface by bonding the flexible light source to a solid surface having the desired shape. Refer now to FIG. 9, which is a cross-sectional view of a light source 90 that includes a concave light-emitting surface. Light source 90 is constructed by bonding a flexible light source 91 to a solid form 92 having a concave surface thereon.

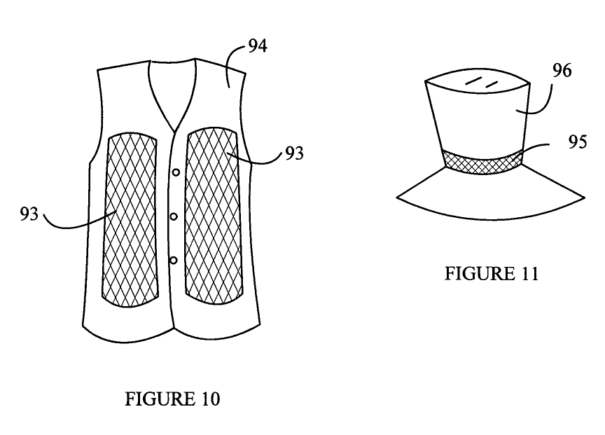

In addition to providing a rigid light-emitting surface of an arbitrary shape, the present invention can also be used to provide flexible surfaces that emit light in predetermined patterns. For example, a light source according to the present invention can be attached to a garment such as a vest or a hat to provide decorations that emit light. Refer now to FIGS. 10 and 11, which illustrate light sources according to the present invention attached to various garments. FIG. 10 shows a pair of display panels 93 attached to the front of a vest 94. FIG. 11 shows a display panel in the form of a hat band 95 attached to a hat 96. For example, such garments could be worn by performers on the stage. The LEDs can be set in a predetermined pattern that provides the desired illuminated design when the light source is turned on. Alternatively, an LED display having a two-dimensional array of LEDs in which individual LEDs can be powered at different levels can be provided so that the garment can present a wide range of illuminated designs that change over time.

In the above-described embodiments of the present invention, the LED dies are mounted directly on the metal layer of the flexible circuit carrier, and it is assumed that substantially all of the light leaving the dies does so through the top surface of the die. However, many LEDs emit a significant fraction of the light generated therein through the sidewall of the die. This light is trapped within the layered structure of the die because of the large difference in the index of refraction between the die materials and air. The trapped light is reflected internally until it reaches the edge of the die. The light striking the edge of the die does so at angles greater than the critical angle, and hence, escapes the die. To collect this light, reflectors can be included in the light source to direct this side-emitted light into the forward direction.

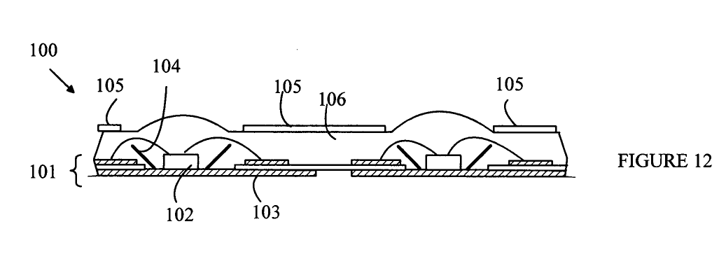

Refer now to FIG. 12, which is a cross-sectional view of a light source 100 according to another embodiment of the present invention. Light source 100 includes a flexible circuit carrier 101 on which LED dies 102 are mounted. The LED dies emit light from both the top and side surfaces of the LED dies. The light that is emitted from the side surfaces of the dies is redirected into the forward direction by a small reflector 104 that is attached to the bottom of metallic surface 103 of flexible circuit carrier 101. The dies are covered with a flexible, clear encapsulating layer in a manner analogous to that described above.

The reflectors can be attached to the metallic layer 103 in the form of a cup on which the dies are actually mounted. Alternatively, the reflectors can be formed in the metallic layer by a punching operation. Since such reflectors and their construction are known to the art, the details of their construction will not be discussed here.

Refer again to FIG. 6. Consider the light emitted from one of the LEDs. A significant fraction of this light will reach the opposite wall of light pipe 51 without being scattered out of the light pipe. Most of this light will strike the edge of the light pipe in areas between the LEDs. To prevent this light from being lost, the areas between the LEDs can be coated with a reflecting layer as shown at 105 in FIG. 12. The reflective coating can be applied using conventional lithographic techniques to the outer surface of layer 106, leaving the areas above the LEDs clear. Hence, a significant fraction of the light that would otherwise be lost is reflected back into the light pipe.

The above-described embodiments of the present invention have been described in terms of more or less rectangular arrays of LEDs that are much longer than wide. However, it is to be understood that an array of LEDs according to the present invention can be of any shape. The LEDs in these arrays can be addressed in groups or individually. For inexpensive arrays that are used to provide a single predetermined illuminated pattern, group addressing is less expensive. However, the present invention can be used to create a flexible, two-dimensional, general display that is capable of providing full color images that can be changed at will.

The above-described embodiments of the present invention utilize dies that include LEDs. However, other semiconductor light emitting elements can also be used in place of, or in addition to, LEDs. For example, semiconductor lasers such as VCSELs or organic LEDs can also be utilized.

Various modifications to the present invention will become apparent to those skilled in the art from the foregoing description and accompanying drawings. Accordingly, the present invention is to be limited solely by the scope of the following claims.

What is claimed is:

1. A light source comprising a flexible light generating module comprising:
a flexible circuit carrier comprising a sheet of flexible material having electrically conducting traces;
a plurality of light emitting dies electrically connected to said electrically conducting traces; and
a cover layer of transparent, flexible material covering said light emitting dies.

2. The light source of claim 1 wherein said sheet of flexible material comprises a heat-conducting layer and wherein said light emitting dies are mounted on said heat-conducting layer.

3. The light source of claim 2 wherein said heat conducting layer comprises a metallic layer on one surface of said sheet.

4. The light source of claim 3 further comprising a light pipe comprising a planar layer of transparent material characterized by a light pipe thickness and top and bottom surfaces, said light generating module being positioned adjacent to a first edge of said planar layer such that light from said light emitting dies enters said first edge and is reflected between said top and bottom surfaces, said light pipe comprising light scattering centers for scattering light in said planar layer at angles that allow said light to exit said top surface.

5. The light source of claim 4 wherein said light pipe further comprises a second edge, said light generating module also being positioned adjacent to said second edge such that light from said light emitting dies enters said second edge and is reflected between said top and bottom surfaces.

6. The light source of claim 4 wherein said light generating module further comprises a sensor for measuring the intensity of light leaving said light pipe.

7. The light source of claim 1 wherein said cover layer comprises an optical element for imaging light from at least one of said light emitting dies.

8. The light source of claim 7 wherein said optical element comprises a lens constructed from said transparent, flexible material.

9. The light source of claim 1 further comprising a shape-determining carrier having a non-planar surface bonded to said flexible circuit carrier.

10. The light source of claim 9 wherein said non-planar surface is ridged.

11. The light source of claim 9 wherein said non-planar surface is concave.

12. The light source of claim 9 wherein said non-planar surface is convex.

13. The light source of claim 9 wherein said sheet of flexible material comprises a heat-conducting layer, wherein said light emitting dies are mounted on said heat conducting layer, and wherein said non-planar surface is bonded to said heat conducting layer.

14. The light source of claim 1 further comprising a garment having an outer surface that is visible when said garment is worn, said flexible light generating module being attached to said outer surface such that light from said light emitting dies are visible to someone other than a person wearing the garment.
